(19) United States
(12) Patent Application Publication
(10) Pub. No.: US 2022/0393302 A1
(43) Pub. Date: Dec. 8, 2022

(54) METHOD FOR MANUFACTURING A POROUS FILM

(71) Applicant: Creonia E.U., Perg (AT)

(72) Inventor: Markus UNGERANK, Perg (AT)

(73) Assignee: Creonia E.U., Perg (AT)

(21) Appl. No.: 17/773,320

(22) PCT Filed: Nov. 5, 2019
(86) PCT No.: PCT/AT2019/060374

§ 371 Date: Apr. 29, 2022

(51) Int. Cl. H01M 50/449; H01M 50/414; H01M 50/406

(52) U.S. Cl. CPC H01M 50/449; H01M 50/414; H01M 50/406

(57) ABSTRACT

The present invention relates to a method for manufacturing a single-layer or multi-layer porous film, said method comprising the following steps: a) providing a flowable first base mixture for a first film layer of the film, the first base mixture comprising a solvent, a filler that is insoluble in the solvent, and a polymeric binder that is dissolved in the solvent; b) forming a film precursor film, the film precursor film comprising at least one sub-layer composed of the first base mixture; c) bringing the film precursor film into contact with a precipitant, the solvent of the first base mixture being soluble in the precipitant, the binder being insoluble in the precipitant, and the binder being precipitated to form the porous film. The invention also relates to a film manufactured using said method, an electrode material manufactured from said film, and an energy storage medium comprising said electrode material.

### CROSS-REFERENCE TO RELATED APPLICATION(S)

This application is the National Stage of International Patent Application No. PCT/AT2019/060374 filed on Nov. 5, 2019, which is herein incorporated by reference in its entirety.

### BACKGROUND

### 1. Field

The present invention relates to a method for preparing a porous film according to the independent patent claim. Further, the invention relates to a film prepared using the inventive method, an electrode material comprising this film, and an energy storage medium comprising this electrode material.

### 2. Related Art

Lithium (Li-)ion batteries are seen as the key to further expansion in the areas of electromobility and stationary power storage. The advantage of the Li-ion technology lies, among other things, in its significantly higher energy and power density compared with other energy storage systems and its low self-discharge.

However, the production of Li-ion batteries known in the prior art is associated with considerable manufacturing challenges, which arise, among other things, from extreme precision requirements, for example with regard to the layer thicknesses of the individual electrodes. In addition, known Li-ion batteries typically require complicated manufacturing steps. The variety of cell types available on the market further increases the complexity.

According to estimates, two thirds of the costs in a state-of-the-art series production are attributable to the material used. The way to lower manufacturing costs can therefore be through higher throughput, fewer rejects and cheaper cathode materials.

A major limiting aspect is the production of the individual components for the battery cells or batteries. In the state of the art, for the production of Li-ion battery cells, the cathode, anode and the electrically insulating separator arranged between the cathode and anode are manufactured separately and then processed in a complex process to form cells of different geometry.

The thickness of the anode and cathode is limited by the process, since the manufacturing process in the prior art involves the evaporation of a solvent, for example in a belt furnace. If the thickness of the films produced in this way increases, uniform evaporation of the solvent is no longer guaranteed and the electrodes may have an inhomogeneous structure, which impairs their quality. Thicker coatings of anodes and/or cathodes also lead to increased equipment costs due to longer drying distances, since the evaporation time of the solvent increases as the square of the thickness of the coating. However, thicker electrodes or films for electrode materials would be desirable to improve the storage capacity of Li-ion batteries.

### SUMMARY

One object of the present invention is to solve this conflict of goals and to create a method that enables the production of thicker films while maintaining the same quality, the films being preferably suitable for the production of electrode materials for Li-ion batteries.

This object is solved by a method with the features of the independent patent claim.

The present invention also relates to a method for preparing a single-layer or multi-layer porous film.

Optionally, the following method steps are provided:
a) providing a flowable first base mixture for a first film layer of the film, wherein the first base mixture comprises a solvent, an additive insoluble in the solvent and a polymeric binder dissolved in the solvent,
b) forming a film precursor sheet, wherein the film precursor sheet comprises at least a sublayer of the first base mixture, and
c) contacting the film precursor sheet with a precipitant, wherein the solvent of the first base mixture is soluble in the precipitant, wherein the binder is at least partially insoluble in the precipitant, and wherein the binder is precipitated to form the porous film.

Optionally, it is provided that in addition to providing a flowable first base mixture, the method comprises:
providing a flowable second base mixture for forming a second film layer, wherein the second base mixture comprises a solvent, an additive insoluble in the solvent and a polymeric binder dissolved in the solvent, and
providing a flowable third base mixture for forming a separating layer, wherein the separator mixture comprises a solvent and a polymeric binder dissolved in the solvent,

Optionally, it is provided that the film precursor sheet comprises a second sublayer of the second base mixture and a third sublayer of the third base mixture, wherein the sublayers extend parallel to each other in the main extension direction of the film precursor sheet.

Optionally, it is provided that the binder of the base mixtures is at least partially insoluble in the precipitant, wherein the binder is precipitated to form the porous film.

Optionally, it is provided that the third base mixture is substantially free from electrically conductive components/is electrically non-conductive.

Optionally, it is provided that for forming the film precursor sheet, the third base mixture is arranged between the first base mixture and the second base mixture.

Optionally, it is provided that the polymeric binder of the base mixture(s) comprises or consists of polysulfones, polyimides, polystyrene, carboxymethyl cellulose, polyether ketones, polyethers, polyelectrolytes, fluorinated polymers, in particular polyvinylidene fluoride, or a mixture of at least two of them.

Optionally, it is provided that the solvent of the base mixture(s) comprises or consists of dimethylacetamide, dimethyl formamide, N-methyl pyrrolidone, N-ethyl pyrrolidone, sulfolane, dimethyl sulfoxide, methanol, ethanol, isopropanol, water, or a mixture of at least two of them.

Optionally, it is provided that the additive is an electroactive agent.

Optionally, it is provided that the electroactive agent comprises or consists of a lithium oxide and/or a lithium sulfide and/or a lithium fluoride and/or a lithium phosphate, in particular lithium manganese dioxide, lithium cobalt dioxide, lithium nickel manganese cobalt dioxide, lithium nickel cobalt aluminum oxide, lithium nickel manganese spinel, lithium nickel manganese dioxide, lithium iron phosphate, lithium manganese phosphate, lithium cobalt phosphate, or any mixture thereof.

Optionally, it is provided that the electroactive agent comprises or consists of graphite, graphene, silicon nanoparticles, lithium titanate, tin, or a mixture thereof.

Optionally, it is provided that the base suspension additionally comprises a conductive agent, wherein the conductive agent comprises or consists of conductive carbon, in particular carbon black, graphene or graphite.

Optionally, it is provided that the precipitant comprises or consists of water, at least one alcohol, such as methanol, ethanol, isopropanol, the solvent of a base mixture, or a mixture thereof.

Optionally, it is provided that forming the film precursor sheet comprises the unsupported extrusion of the base mixture(s), preferably the unsupported coextrusion of the first base mixture, the second base mixture and the third base mixture.

Optionally, it is provided that after step (b) and before step (c) the film precursor sheet is brought into contact, in particular coated over its surface, with a pre-precipitant on one or both sides, the binder of the base mixture(s) being insoluble in the pre-precipitant.

Optionally, it is provided that the method additionally comprises the following step: washing the film in a washing solution, wherein the washing solution preferably comprises or consists of water or at least one alcohol, such as methanol, ethanol, isopropanol, or a mixture thereof.

Optionally, it is provided that the method additionally comprises the following step: drying the film in a drying apparatus, preferably a belt or drum dryer, with recirculating air or an inert gas.

Optionally, it is provided that the method additionally comprises the following step: compacting the film in a press apparatus, a roller apparatus or a calendaring apparatus, preferably under the influence of a temperature of more than 50° C. or compacting the film by thermal shrinking.

Further, the invention relates to a porous film prepared with a method according to the invention.

Optionally, it is provided that the film has a preferably substantially constant thickness between 50 μm and 1000 μm, preferably between 200 μm and 500 μm.

Optionally, it is provided that the film comprises a first film layer, a second film layer and a separating layer arranged between the first and the second film layer, wherein the first film layer and the second film layer have a thickness between 20 μm and 500 μm, and wherein the separating layer has a thickness between 5 μm and 50 μm.

Optionally, it is provided that the separating layer is an electrical insulator.

Optionally, it is provided that the first film layer and the second film layer are electrical insulators.

The invention further relates to an electrode material, comprising an inventive film and a current dissipation layer arranged on the outer surfaces of the electrode material.

Optionally, the electrode material comprises at least two layers of an inventive film.

The invention further comprises an energy storage medium, comprising an inventive electrode material and an electrolyte and two contacting elements.

Further features of the invention can be derived from the description, the patent claims, the exemplary embodiments, the figures and the preferred aspects of the invention.

In the inventive method, a first base mixture may be provided, which is formulated to form a first film layer. The first base mixture may comprise at least a solvent, an additive insoluble in the solvent and a polymeric binder dissolved in the solvent.

Advantageously, the film prepared using the method according to the invention is a multi-layer film. In this case, the assembling step of the individual electrodes for producing a cell is not necessary and a potential source of error is eliminated. In addition, compared to the preparation of individual layers, the mechanical stability of the film is increased and individual sublayers can be made thinner, if necessary.

Accordingly, a second base mixture may be provided in addition to the first base mixture. The second base mixture may comprise at least a solvent, an additive insoluble in the solvent and a polymeric binder dissolved in the solvent.

In addition to the first base mixture and the second base mixture, a third base mixture may also be provided. The third base mixture may comprise at least a solvent and a polymeric binder dissolved in the solvent. The third base mixture may be free from insoluble additives. Alternatively, the third base mixture by comprise insoluble additives, which are preferably electrically non-conductive.

In addition to the first, second and third base mixtures, further base mixtures may also be provided, depending on the requirements for the final film product.

For example, a fourth and a fifth base mixture may be provided, which are adapted to form discharge protection layers. The fourth and fifth base mixtures may be arranged between the first and third/between the second and third sublayer when forming the film precursor sheet. The fourth and fifth base mixtures may in particular comprise a polymeric material with a low melting point as binder. In particular, the melting point of this binder is below 100° C., preferably below 80° C.

In a preferred embodiment, it is provided that the first base mixture is adapted to form an anode material, the second base mixture is adapted to form a cathode material and the third base mixture is adapted to form a separating layer arranged between the cathode material and the anode material. Preferably, the anode material and the cathode material are electrically conductive. Preferably, the separating layer is electrically insulating.

Accordingly, the first base mixture and the second base mixture contain preferably conductive components, in particular conductive additives insoluble in solvent. Particularly preferably, the additives can be electroactive agents, can absorb or release ions, preferably can absorb or release lithium ions. Preferably, the third base mixture contains no conductive components. However, the third base mixture may contain additives insoluble in solvent, which however are not electrically conductive. These additives or fillers may improve the stability of the separating layer during further processing steps. However, optionally, the third base mixture may not contain insoluble additives.

The individual components of the base mixtures may by the same, partially the same or completely different. For example, the first base mixture may comprise a polyimide as polymeric binder and N-methyl pyrrolidone as solvent, while the second base mixture comprises polystyrene as polymeric binder and dimethyl formamide as solvent.

Film precursor sheets can be formed from the base mixtures. Preferably, the base mixtures have a viscosity that allows extrusion of the base mixtures, doctoring of the base mixtures, or use of another process known in the prior art to form thin layers.

The base mixture(s) may independently have a viscosity greater than 10² mPa*s, preferably greater than 10³ mPa*s, more preferably greater than 10⁴ mPa*s.

The film precursor sheet is preferably a multi-layer film precursor sheet comprising a plurality of sublayers. The sublayers run substantially parallel to each other and there is no substantial mixing of the sublayers. According to the solubilities, some mixing of the components of the individual sublayers may occur in the regions near the interface.

Preferably, the film precursor sheet is formed by coextrusion of the base mixtures.

After the film precursor sheet is formed, it is brought into contact with, preferably immersed in, a precipitant. The binder(s) of the base mixtures are at least partially insoluble in the precipitant, so that the binder(s) are precipitated upon contact with the precipitant. This phase inversion reaction can result in the formation of a porous film. The physical properties of the film are largely dependent on the degree of insolubility of the binder(s) in the precipitant.

As a result, a self-supporting film is formed that preferably does not require any supporting medium. When the precursor sheet is prepared using an extrusion process, the obtained porous film can be obtained as a continuous material.

The film may preferably have a plurality of sublayers, in particular a first film layer, a second film layer and a separating layer disposed between the first and second film layers. The composition of the first film layer is in particular derived from the first base mixture, the composition of the second film layer is derived from the second base mixture and the composition of the separating layer is derived from the third base mixture.

In a preferred embodiment of the film, the first film layer is an anode layer, the second film layer is a cathode layer and the third film layer is a separator layer. The cathode layer may comprise in particular a lithium metal oxide or a lithium metal phosphate as electroactive agent.

If discharge protection layers are provided between the cathode layer and the separating layer or between the anode layer and the separating layer, they can prevent the discharge of an energy storage medium at a certain temperature. If the cell temperature exceeds the melting point of the binder of the discharge protection layers, the binder penetrates the pores of the separating layer and closes them so that charge exchange between the cathode layer and the anode layer can no longer take place.

Additional method steps may be provided to further improve the inventive production method.

Before being brought into contact with the precipitant, the film precursor sheet can be brought into contact on one or both sides with a pre-precipitant. This can have different solubility properties than the precipitant and thus initiate a first precipitation step. The contacting with the pre-precipitant may be done directly before the contacting with the precipitant, for example by spraying the precursor sheet with the pre-precipitant. Optionally, different pre-precipitants may be applied to both sides of the precursor sheet. The pre-precipitant may also be extruded in addition to the base mixtures.

Optionally, the pre-precipitant may have the same composition as the precipitant.

By applying the pre-precipitant, rapid coagulation of the binder in the outer layers of the film precursor sheet can be achieved. Thus, a skin-like surface can be formed, which can suppress fluctuations in the thickness and a taper in the width of the obtained film during extrusion. In addition, the use of a pre-precipitant allows selective adjustment of porosity and wettability on the surface of the film.

The final coagulation of the binder and the formation of the porous film take place in the precipitant, which is preferably contained in a precipitation bath. The pore structure of the film can be varied by adjusting parameters such as binder concentration in the base mixtures, type of solvent used in the base mixtures, composition of the precipitant, temperature of the precipitant, etc.

Optionally, the porous film formed may be further transported via an arrangement of rollers or rolls. Optionally, after forming the film, the film may be introduced into a washing solution to remove precipitants, solvents and other impurities.

Optionally, after washing, the film may be run through another wash bath to displace the detergent or washing solution from the first washing bath. Optionally, after the washing baths, the film may be run through a dryer to evaporate the detergent or the washing solution. The high porosity of the film and the low boiling point of the detergent facilitate and accelerate the evaporation of the detergent from the film.

Optionally, the film may be compacted in a press apparatus, such as a rolling apparatus or a calendaring apparatus, to compact the film. The compaction may also be carried out under the influence of heat, such as at a temperature above the softening point of at least one binder, with or without a press apparatus.

The film obtained using the inventive method may have a high porosity. The porosity of the first and second film layers may independently be greater than 0.10, greater than 0.20, greater than 0.30, greater than 0.40, greater than 0.50, greater than 0.60, greater than 0.70, greater than 0.80, or greater than 0.90. The porosity of the first and second film layers may independently be less than 0.99, less than 0.95, or less than 0.90.

In an embodiment, the porosity of an anode layer is between 0.2 and 0.4. In an embodiment, the porosity of a cathode foil is between 0.5 and 0.7.

The porosity of the separating layer may in particular be greater than the porosity of the first and second film layers. A high porosity of the separating layer leads to low resistances, which is advantageous regarding a low cell resistance. The porosity of the separating layer may be greater than 0.20, greater than 0.30, greater than 0.40, greater than 0.50, greater than 0.60, greater than 0.70, greater than 0.80, or greater than 0.90. The porosity of the separating layer may be less than 0.99, less than 0.95, or less than 0.90. In an embodiment, the porosity of the separating layer is between 0.2 and 0.4.

The pores may be distributed homogeneously in the individual film layers, but a gradual pore size distribution and/or porosity distribution may also be provided, for example if a pre-precipitant is used in the production method. Then the parts of the film close to the surface can have a different porosity with different sized pores than the parts further inside. The above porosity values refer in particular to the average porosity of the film layers.

The average pore size of the film layers and the separating layer may independently be between 100 nm and 5 μm, in other embodiments between 500 nm and 2 μm, in other embodiments between 200 nm and 1 μm.

The film according to the invention may be further processed into an electrode material for an energy storage medium. For this purpose, a metallic current dissipation layer can be applied to the outer surfaces of the film, for example by laminating or by vapor deposition. The current dissipation layers may be formed from aluminum, copper or other materials known for Li-ion batteries.

Optionally, the multi-layer films prepared using the method of the invention may be processed into a multi-layer film composite to form a multi-layer battery cell with increased cell voltage. Thus, the battery cell according to the invention may optionally comprise two, three, four, five or more layers of a porous multi-layer film according to the invention.

This allows energy storage media with particularly high energy densities to be prepared, while further reducing the amounts of metals required for current dissipation. In particular, an electrode material comprising such a multi-layer film composite may be provided with current dissipation layers only on its outermost layers. It is possible to dispense with a metallic coating on the inner porous films if the surface of the films is impermeable to lithium ions, which is the case, for example, when certain pre-precipitants are used.

The multi-layer electrode material may then be incorporated into an energy storage medium. For this purpose, two contacting elements are attached to the electrode material and the material is loaded with an electrolyte. The electrolyte fills the pores of the film and allows Li⁺ ions to be conducted.

In the context of the present invention, the term “dissolved” may mean that a component or a substance is completely solubilized in an agent, especially in a solvent, that is, that component or substance is not in solid form.

In the context of the present invention, the term “insoluble” may mean that a constituent or substance is not soluble in a liquid. Optionally, negligible fractions, such as less than 0.5%, preferably less than 0.1%, more preferably less than 0.01% may be soluble for a component or substance to be considered insoluble.

In the context of the present invention, the term “electrically conductive” may mean that a material or substance has an electrical conductivity greater than 10⁴ S/m, preferably greater than 10⁵ S/m, more preferably greater than 10⁶ S/m.

In the context of the present invention, the terms “electrically insulating” or “electrically non-conductive” may mean that a material or substance has an electrical conductivity of less than 10⁻⁶ S/m, preferably less than 10⁻⁷ S/m, more preferably less than 10⁻⁸ S/m.

In the context of the present invention, the terms “foil”, “film”, “membrane” and the like may be used interchangeably.

Further optional aspects of the invention are given below. These aspects may be provided individually or in any combination in the context of the present invention.

According to a first optional aspect, the method is a continuous method.

According to a second optional aspect, the additive is suspended in the base mixture(s).

According to a third optional aspect, the at least one conductive agent is suspended in the base mixture(s).

According to a fourth optional aspect, the additive and/or the conductive agent are formed of or comprise nanoparticles.

According to the fourth aspect of the invention, the nanoparticles may be silicon nanoparticles, preferably having an average size from 10 nm to 200 nm, more preferably from 50 nm to 100 nm.

According to a fifth optional aspect, the base mixtures have different compositions.

According to a sixth optional aspect, at least one binder is a crosslinkable polymer. Optionally, the crosslinkable polymer is swellable upon receiving an electrolyte.

According to a seventh optional aspect, all or at least part of the binder is a polyelectrolyte having carboxylic and/or sulfonic acid groups.

According to an eighth optional aspect, the method for forming the film from the film precursor material is a phase inversion method for coagulating the binder.

According to a ninth optional aspect, the extrusion of the base mixture(s) is performed using a sheet die or multiple sheet dies or a multi-channel sheet die. Preferably, the width of the die(s) is between 5 cm and 200 cm, particularly preferably between 10 cm and 50 cm.

According to an embodiment of the ninth optional aspect, a pre-precipitant may be provided in further sheet dies or in further channels of the multi-channel sheet die.

According to a tenth optional aspect, the temperature of the precipitant may be between 0° C. and 80° C., in other aspects between 10° C. and 50° C., in other aspects between 40° C. and 80° C., in other aspects between 30° C. and 60° C.

According to an eleventh optional aspect, the extrusion speed of the film precursor sheet may be between 2 m/min and 50 m/min.

According to a twelfth optional aspect, contacting in step (b) of the method may comprise placing or immersing the precursor sheet in the precipitant.

According to a thirteenth optional aspect, a pretreatment of the base mixture(s) may be performed prior to step (a) of the method.

According to the thirteenth aspect, the pretreatment may comprise one or more of the following:

deagglomeration of the base mixture(s), e.g., using a sawtooth disc impeller and/or via an ultrasonic treatment,

filtration of the base mixture(s), e.g., using an edge gap filter, a cartridge filter, a fabric filter, or the like, and

degassing of the base mixture by means of vacuum, either directly or via a membrane.

According to a fourteenth optional aspect, the method may additionally comprise one or more of the following steps:

washing step, optionally passing the film material over deflection rollers or rolls, optionally passing a washing solution in countercurrent to the movement of the film material,

drying step to evaporate detergents, solvents, pre-precipitants, precipitants and other volatile components,

compacting step to adjust the porosity of the films by temperature treatment and/or compaction, and

rolling step to form a film roll, optionally by arranging a spacer material between the individual film layers.

According to a fifteenth optional aspect, the third base material may comprise an electrically non-conductive or electrically inactive additive, such as silicon dioxide and/or aluminum oxide.

According to a sixteenth optional aspect, the inventive film is a polymer composite material.

According to a seventeenth optional aspect, the inventive film is a continuous material.

According to an eighteenth optional aspect, the inventive film is a self-supporting film having a foam-like structure between the particles of the additives.

According to a nineteenth optional aspect, the electrode material comprises a current dissipation layer made of copper or aluminum, optionally having a thickness of less than 20 μm, preferably less than 5 μm, particularly preferably less than 1 μm.

According to a twentieth optional aspect, at least one current dissipation layer is made by metallizing, wherein the vapor deposition method is optionally performed continuously.

According to a twenty-first optional aspect, at least one current dissipation layer is made by galvanic metal coating.

According to a twenty-second optional aspect, on the energy storage medium of the invention, the side surfaces are sealed by melting the bonding agent or by applying an adhesive.

According to a twenty-third optional aspect, the contacting elements are formed of a nickel strip and/or aluminum strips bonded or welded to the electrode material with a conductive adhesive.

In the following, the invention will be explained in detail with reference to exemplary embodiments. In connection with the exemplary embodiments:

### BRIEF DESCRIPTION OF THE DRAWINGS

FIG. 1 shows a schematic process flow diagram of a second exemplary embodiment of a method according to the invention;

FIG. 2 shows a schematic representation of an energy storage medium comprising a film prepared by methods of the second exemplary embodiment.

### DETAILED DESCRIPTION OF THE PREFERRED EMBODIMENTS

Unless otherwise indicated below, the following elements are shown in the figures: dissolving tank 1, homogenizer 2, cartridge filter 3, storage tank 4, line 5, extruder 6, line 7, precipitating liquid tank 8, precipitating bath 9, circulating pump 10, deflection roller 11, washing bath 12, drying furnace 13, winding apparatus 14, electrode material 15, contacting element 16, cell housing 17, anode layer 18, cathode layer 19, separating layer 20, film precursor sheet 21, film 22, roller 23, metal layer 24, degassing apparatus 25.

### Example 1

According to a first exemplary embodiment, a method for preparing a single-layer porous film is provided. Two of these films are used to prepare an energy storage medium. The compositions of the base mixtures of the two films are indicated in table 1.

TABLE 1

| | First film | Weight | Second film | Weight |
|---|---|---|---|---|
| | (anode foil) | fraction (%) | (cathode foil) | fraction (%) |
| Solvent | Dimethyl- | 59.7 | Dimethyl- | 53.2 |
| | acetamide | | acetamide | |
| Binder | Polyvinylidene | 4.2 | Polyvinylidene | 4.7 |
| | difluoride | | difluoride | |
| Electroactive | Graphite | 35.7 | Lithium iron | 40.7 |
| agent | | | phosphate | |
| Conductive | Carbon black | 0.4 | Carbon black | 1.4 |
| agent | | | | |

The graphite has an average particle diameter of about 15 μm, the lithium iron phosphate of about 2.0 μm, and the carbon black of about 0.05 μm.

Two base mixtures are prepared, first dry-blending the powder binder with the insoluble particulate solids, i.e., the electroactive agent and the conductive agent. Then the powder mixture thus prepared is added to the solvent. The mixture is homogenized and then filtered through an ultrasonic sieve to separate any agglomerates it may contain, which are larger than about 50 μm. The suspension is degassed under vacuum.

Each base mixture is applied to a glass plate with a doctor blade to form a film precursor sheet with a single sublayer. The thickness of the first sublayer thus prepared is about 250 μm for the anode foil and about 350 μm for the cathode foil.

The glass plate with the single-layer film precursor sheet is then immersed in a bath of precipitant at room temperature, using deionized water as the precipitant. After a residence time of about 10 min in the precipitant, the glass plate is removed from the precipitation bath. The films with dimensions of about 30×20 cm can be removed manually from the glass plate. After a washing step in a washing bath with deionized water, the films are dried in air.

The obtained films are characterized using scanning electron microscopy. An average pore size of about 1.5 μm is determined. The porosity of the prepared film is about 0.65. The thicknesses of the films are about 145 μm for the anode foil and 150 μm for the cathode foil. Sample pieces of the single-layer anode and cathode foils with a size of 70 mm×70 mm are pressed between two plane-parallel steel plates at room temperature in a lever press with a pressure of 0.3 to/cm². The thickness of the anode foil after pressing is about 70 μm with a porosity of about 0.32, and the thickness of the cathode foil is about 100 μm with a porosity of about 0.45. The foils do not lose their good mechanical properties and flexibility.

The basis weight of the anode foil is about 100 g/m², and the basis weight of the cathode foil is about 180 g/m², which is two to three times the basis weight of anode and cathode coatings prepared by the classical method with solvent evaporation in a belt dryer.

An electrode material is formed from the films by placing a separating layer of a commercially available polyethylene membrane (e.g., from Celgard) between an anode foil and a cathode foil. An aluminum foil is arranged on the surface of the cathode foil and a copper foil is arranged on the surface of the anode foil as a current dissipation layer.

The electrode material is processed into a pouch cell as an energy storage medium in a form known in the art. The cells obtained have a typical cell voltage, and several charge and discharge cycles are possible.

### Example 2

According to a second embodiment, a further method for preparing a single-layer porous film is provided. Two of these films are used to prepare an energy storage medium. The compositions of the base mixtures of the two films are indicated in table 2.

TABLE 2

| | First film | Weight | Second film | Weight |
|---|---|---|---|---|
| | (anode foil) | fraction (%) | (cathode foil) | fraction (%) |
| Solvent | Dimethyl- | 53.5 | Dimethyl- | 53.4 |
| | acetamide | | acetamide | |
| Bonding | Polyvinylidene | 4.7 | Polyvinylidene | 4.6 |
| agent | difluoride | | difluoride | |
| Electroactive | Graphite | 41.4 | LiNCM523 | 39.1 |
| agent | | | (Lithium | |
| | | | Nickel0.5 | |
| | | | Cobalt0.2 | |
| | | | Manganese0.3 | |
| | | | Oxide) | |
| Conductive | Carbon black | 0.5 | Carbon black | 2.8 |
| agent | | | | |

The graphite has an average particle diameter of about 1.5 μm, the lithium nickel cobalt manganese oxide of about 4.0 μm, and the carbon black of about 0.05 μm.

Two base mixtures are prepared, first dry-blending the powder binder with the insoluble particulate solids, i.e., the electroactive agent and the conductive agent. Then the powder mixture thus prepared is added to the solvent. The mixture is homogenized and then filtered through an ultrasonic sieve to separate any agglomerates it may contain, which are larger than about 50 μm. The suspension is degassed under vacuum.

Each base mixture is applied to a glass plate with a doctor blade to form a film precursor film with a single sublayer. The thickness of the first sublayer thus prepared is about 140 μm for the anode foil and about 210 μm for the cathode foil.

The glass plate with the single-layer film precursor film is then immersed in a bath of precipitant at room temperature, using deionized water as the precipitant. After a residence time of about 10 min in the precipitant, the glass plate is removed from the precipitation bath. The films with dimensions of about 30×20 cm can be removed manually from the glass plate. After a washing step in a washing bath with deionized water, the films are dried in air.

The obtained films are characterized using scanning electron microscopy. An average pore size of about 1.5 μm is determined. The porosity of the prepared films is about 0.55 for the cathode foil and 0.62 for the anode foil. The thicknesses of the films are about 100 μm for the anode foil and 100 μm for the cathode foil. Sample pieces of the single-layer anode and cathode foils with a size of 70 mm×70 mm are pressed between two plane-parallel steel plates at room temperature in a lever press with a pressure of 0.1 to/cm². The thickness of the anode foil after pressing is about 85 μm with a porosity of about 0.56, and the thickness of the cathode foil is about 85 μm with a porosity of about 0.47. The foils do not lose their good mechanical properties and flexibility.

The basis weight of the anode foil is about 80 g/m², and the basis weight of the cathode foil is about 139 g/m², which is about twice the basis weight of anode and cathode coatings prepared by the classical method with solvent evaporation in a belt dryer.

An electrode material is formed from the films by placing a separating layer of a commercially available polyethylene membrane (e.g., from Celgard) between an anode foil and a cathode foil. An aluminum foil is arranged on the surface of the cathode foil and a copper foil is arranged on the surface of the anode foil as a current dissipation layer.

The electrode material is processed into a pouch cell as an energy storage medium in a form known in the art. The cells obtained have a typical cell voltage, and several charge and discharge cycles are possible.

### Example 3

According to a second exemplary embodiment, a method for preparing a multi-layer porous film is provided. This film is used to prepare an energy storage medium. In an inventive step of the method, a film precursor sheet is prepared, which consists of three sublayers, each sublayer being formed from a base mixture. The compositions of the base mixtures are indicated in table 3.

TABLE 3

| | First base | | Second base | | Third base | |
|---|---|---|---|---|---|---|
| | mixture | | mixture | | mixture | |
| | (anode | | (cathode | | (separating | |
| | layer) | wt.-% | layer) | wt.-% | layer) | wt.-% |
| Solvent | Dimethyl- | 59.7 | Dimethyl- | 53.2 | Dimethyl- | 92.0 |
| | acetamide | | acetamide | | acetamide | |
| Binder | Polyvinylidene | 4.2 | Polyvinylidene | 4.7 | Polyvinylidene | 8.0 |
| | difluoride | | difluoride | | difluoride | |
| Electroactive | Graphite | 35.7 | Lithium iron | 40.7 | — | 0 |
| agent | | | phosphate | | | |
| Conductive | Carbon black | 0.4 | Carbon black | 1.4 | — | 0 |
| agent | | | | | | |

The graphite has an average particle diameter of about 15 μm, the lithium iron phosphate of about 2 μm and the carbon black of about 0.05 μm.

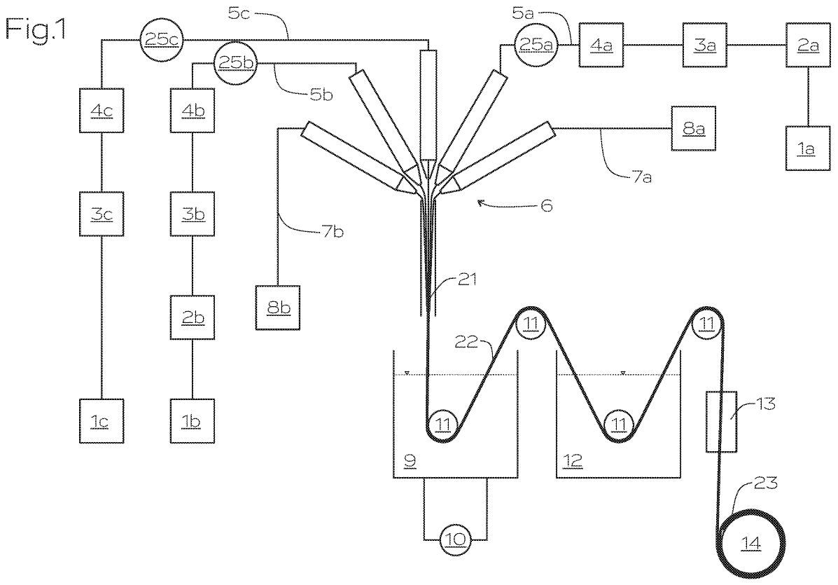

The inventive production method according to this second exemplary embodiment is illustrated in a process flow diagram in FIG. 1.

The base mixtures are prepared by first dissolving the binder completely in the solvent. The binder solutions are prepared in the dissolving tanks 1a, 1b, 1c. In the case of the first and second base mixtures, the insoluble particulate solids, i.e., the electroactive agent and the conductive agent, are then added and the mixture is homogenized in the homogenizers 2a, 2b. All three base mixtures are then filtered through cartridge filters 3a, 3b, 3c to separate any agglomerates or other solids with a particle size of more than 30 μm that may be contained.

Then the prepared base mixtures are placed in storage tanks 4a, 4b, 4c, where they can be stored until further processing. Agitators are provided in each of the storage tanks 4a, 4b, 4c to ensure homogeneity of the base mixtures and prevent settling of particulate components. The base mixtures are fed in separate lines 5a, 5b, 5c to an extruder 6, which is designed as a multi-slot extruder with five sheet dies, each 15 cm wide. Degassing apparatuses 25a, 25b, 25c, in this case degassing membranes, are located in each of the lines 5a, 5b and 5c.

The base mixtures are introduced into the three central nozzles, with the third base mixture positioned centrally between the first base mixture and the second base mixture.

The two outermost nozzles are connected to precipitation liquid tanks 8a, 8b via lines 7a, 7b. In this exemplary embodiment, the precipitation liquid is deionized water and is brought into contact with the surfaces of the film precursor sheet 21 emerging from the extruder 6 during extrusion.

This results in a pre-precipitation of the binder even before contact with the actual precipitation bath 9.

The film precursor sheet 21 is introduced self-supportingly into the precipitation bath 9, in which the precipitation liquid is contained. In this case, the precipitation liquid is deionized water containing about 2% of the solvent dimethylacetamide. The precipitation liquid is circulated and set in motion in the precipitation bath by means of a circulating pump 10. Excess precipitation liquid leaves the precipitation bath 9 via an overflow and is pumped off and disposed of. The temperature of the precipitation bath is about 40° C. The porous three-layer film 22 formed by coagulation of the binder is led out of the precipitation bath via a deflection roller 11 and transferred to a washing bath 12 via a further deflection roller 11. The film 22 is then dried in a drying oven 13 at about 80° C. and wound onto a roll 23 by a winding apparatus 14. The continuous material thus obtained can be supplied for further use.

The obtained films are characterized using scanning electron microscopy. An average pore size of about 1.5 μm is determined. The porosity of the prepared multi-layer film is about 0.65 for the anode and cathode layers and about 0.85 for the intermediate separating layer. The overall thickness of the film is about 350 μm. Sample pieces of the three-layer film with a size of 70 mm×70 mm are pressed between two plane-parallel steel plates at room temperature in a lever press with a pressure of 0.3 to/cm². The thickness of the film after pressing is about 180 μm, the thickness of the anode layer being about 70 μm, the thickness of the cathode foil being about 100 μm and the thickness of the separating layer being about 10 μm. The films do not lose their good mechanical properties and flexibility during pressing.

The basis weight of the multi-layer film is about 290 g/m².

The outer film layers, i.e., the cathode layer and the anode layer, have a porosity of about 0.45 and 0.32, respectively. The average pore diameters are about 1.5 μm. The inner film layer, i.e., the separating layer, has a porosity of about 0.65. The average pore diameter is about 2.5 μm.

To form an electrode material, 15×10 cm pieces of the continuous material are vapor-deposited on both sides with a metal layer with a thickness of about 1 μm. The surface of the anode layer receives a copper coating, while the surface of the cathode layer receives an aluminum coating.

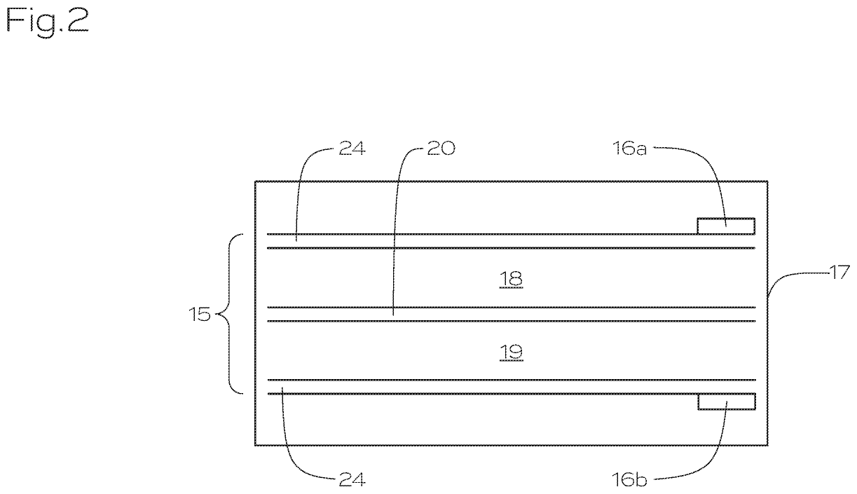

The electrode materials prepared in this way can be further processed to energy storage media. An exemplary energy storage medium is shown in FIG. 2. FIG. 2 is only a sketched illustration of an energy storage medium, and the actual proportions are not shown to scale.

The electrode material 15 is contacted at the metal layer 24 of the anode and cathode sides with contacting elements 16a, 16b, which are nickel electrodes on the anode side, while aluminum contacting elements are used on the cathode side. This arrangement is packed in an airtight manner in a cell housing 17. The electrode material 15 with the anode layer 18, the cathode layer 19 and the separating layer 20 is loaded with an electrolyte which provides free Li⁺ ions as a charge carrier. Wetting is achieved by the capillary action of the pores in the film.

Compared to energy storage media prepared according to the prior art, the manufacturing costs for the production of this energy storage medium according to the invention are about 20 to 25% lower. The mass-based storage density is more than 50% higher than that of conventional energy storage media, and the power-based area requirement is more than 20% lower.

The method according to the invention and the products obtained therefrom may result in the following further advantages over the prior art:
The porosity of the layers is independent of the particle size of the additives used. Therefore, the use of nanoparticles as additives is possible to produce cells for high charge and discharge currents and to enable high diffusion rates of the lithium ions in the pores.
The precipitation process of the binder in the precipitant creates a sponge-like elastic structure between the additives, which imparts strength and toughness to the sublayers. Cracking during manufacture and operation of the materials is greatly reduced.
The separating layer can be particularly thin and highly porous, since it is present as a sublayer and as such does not have to be mechanically resilient.
The reduction of the metal content results in a weight reduction of the cell.
The reduced thickness of the separating layer and an increase in the porosity of the separating layer lead to a reduction in the ohmic internal cell resistance and thus to lower power loss during charging and discharging of the battery.
The lower internal cell resistance allows faster charging compared to the prior art with less heating of the cell. At the same time, faster discharges (high-power cells) are also feasible.
The method allows the use of materials with high softening points and temperature resistances, such as aromatic polyimides, polyamides, polyether ketones or polyether sulfones for the production of separators and electrodes. This is accompanied by increased safety during operation due to the increase in melt-down temperature.

1. A method for preparing a single-layer or multi-layer porous film, comprising the following steps:
a. providing a flowable first base mixture for a first film layer of the film, wherein the first base mixture comprises a solvent, an additive insoluble in the solvent and a polymeric binder dissolved in the solvent,
b. forming a film precursor sheet, wherein the film precursor sheet comprises at least a sublayer of the first base mixture,
c. contacting the film precursor sheet with a precipitant, wherein the solvent of the first base mixture is soluble in the precipitant, wherein the binder is at least partially insoluble in the precipitant, and wherein the binder is precipitated to form the porous film.

2. The method according to claim 1, further comprising:
providing a flowable second base mixture for forming a second film layer, wherein the second base mixture comprises a solvent, an additive insoluble in the solvent and a polymeric binder dissolved in the solvent, and
providing a flowable third base mixture for forming a separating layer, wherein the separator mixture comprises a solvent and a polymeric binder dissolved in the solvent,
wherein the film precursor sheet comprises a second sublayer of the second base mixture and a third sublayer of the third base mixture, wherein the sublayers extend parallel to each other in the main extension direction of the film precursor sheet, and
wherein the binder of the first, second, and third base mixtures is at least partially insoluble in the precipitant, wherein the binder is precipitated to form the porous film.

3. The method according to claim 2, wherein the third base mixture is electrically non-conductive.

4. The method according to claim 2, wherein, for forming the film precursor sheet, the third base mixture is arranged between the first base mixture and the second base mixture.

5. The method according to claim 1, wherein the polymeric binder of the first base mixture comprises or consists of polysulfones, polyimides, polystyrene, carboxymethyl cellulose, polyether ketones, polyethers, polyelectrolytes, fluorinated polymers, in particular polyvinylidene fluoride, or a mixture of at least two of them.

6. The method according to claim 1, wherein the solvent of the first base mixture comprises or consists of dimethylacetamide, dimethyl formamide, N-methyl pyrrolidone, N-ethyl pyrrolidone, sulfolane, dimethyl sulfoxide, methanol, ethanol, isopropanol, water, or a mixture of at least two of them.

7. The method according to claim 1, wherein the additive of the first base mixture is an electroactive agent.

8. The method according to claim 7, wherein:
the electroactive agent comprises or consists of a lithium oxide and/or a lithium sulfide and/or a lithium fluoride and/or a lithium phosphate, or
the electroactive agent comprises or consists of graphite, graphene, silicon nanoparticles, lithium titanate, tin, or a mixture thereof.

9. The method according to claim 1, wherein the first base mixture further comprises a conductive agent, wherein the conductive agent comprises or consists of conductive carbon, in particular carbon black, graphene or graphite.

10. The method according to claim 1, wherein the precipitant comprises or consists of water, at least one alcohol, such as methanol, ethanol, isopropanol, the solvent of a base mixture, or a mixture thereof.

11. The method according to claim 1, wherein the film precursor sheet comprises the unsupported extrusion of the first base mixture.

12. The method according to claim 1, wherein after step (b) and before step (c) the film precursor sheet is coated by a pre-precipitant on one or both sides, the binder of the base mixture(s) being insoluble in the pre-precipitant.

13. The method according to claim 1, further comprising:
washing the film in a washing solution, wherein the washing solution comprises or consists of water or at least one alcohol, such as methanol, ethanol, isopropanol, or a mixture thereof.

14. The method according to claim 1, further comprising:
drying the film in a drying apparatus with recirculating air or an inert gas.

15. The method according to claim 1, further comprising:
compacting the film in a press apparatus, a roller apparatus or a calendering apparatus, or
compacting the film by thermal shrinking.

16. A porous film prepared by a method according to claim 1.

17. The film according to claim 16, wherein the film has a substantially constant thickness between 50 μm and 1000 μm.

18. The film according to claim 16, wherein the film comprises a first film layer, a second film layer and a separating layer arranged between the first and the second film layer, wherein the first film layer and the second film layer have a thickness between 20 μm and 500 μm, and wherein the separating layer has a thickness between 5 μm and 50 μm.

19. The film according to claim 18, wherein the separating layer is an electrical insulator.

20. The film according to claim 18, wherein the first film layer and the second film layer are electrical insulators.

21. An electrode material, comprising a film according to claim 16 and a current dissipation layer arranged on the outer surfaces of the electrode material.

22. The electrode material according to claim 21, comprising at least two layers of a film according to claim 16.

23. An energy storage medium, comprising:
an electrode material according to claim 22,
an electrolyte, and
two contacting elements.
